(19) United States
(12) Patent Application Publication
(10) Pub. No.: US 2017/0348081 A1
(43) Pub. Date: Dec. 7, 2017

(54) DENTURE CLEANING KIT

(71) Applicant: Ronnie Womack, Jackson, GA (US)

(72) Inventor: Ronnie Womack, Jackson, GA (US)

(21) Appl. No.: 15/175,145

(22) Filed: Jun. 7, 2016

(51) Int. Cl. A61C 17/00; A46B 9/04

(52) U.S. Cl. CPC A61C 17/036; A46B 9/04

(57) ABSTRACT

A denture cleaning kit that includes: a wipe; and a cleaning tool, wherein the cleaning tool is used with the wipe to clean dentures. The wipe preferably includes a series of ridges over the surface. The cleaning tool includes a brush at a first end and a knife at a second end. The wipe may be made of cotton and the cleaning tool may be made of plastic.

### BACKGROUND OF THE INVENTION

### Field of Invention

The present invention relates to a kit used for denture cleaning.

### Description of Related Art

Dentures are prosthetic teeth used to replace missing teeth. Dentures are removable and require maintenance during use. Dentures must be kept clean daily as an individual's original teeth in order to maintain quality and length of service of the dentures. Currently many individuals use paste and creams in order to clean their dentures. However, these pastes and creams must be removed by hand creating a somewhat sloppy and messy cleanup process. Typically, denture cream gets over the user's hand and therefore it is difficult to have a clean and effective cleanup process related to the use of dentures.

### SUMMARY OF THE INVENTION

The present invention relates to a denture cleaning kit that includes: a wipe; and a cleaning tool, wherein the cleaning tool is used with the wipe to clean dentures. The wipe preferably includes a series of ridges over the surface. The cleaning tool includes a brush at a first end and a knife at a second end. The wipe may be made of cotton and the cleaning tool may be made of plastic.

### BRIEF DESCRIPTION OF DRAWINGS

FIG. 1 depicts a denture wipe used in conjunction with the present invention.

FIG. 2 depicts a denture cleaning tool used in accordance with the present invention.

### DETAILED DESCRIPTION

The present invention relates to a denture cleaning kit that includes a wipe with rippled ridges over the surface of the wipe. Used in conjunction with the wipe is a denture cleaning tool that includes bristles at a first end and a knife at a second end of the tool to ensure the removal and cleaning of denture cream while cleaning a set of dentures.

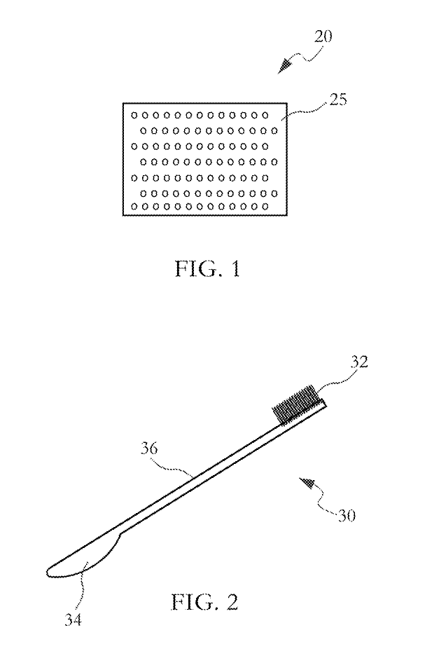

FIG. 1 depicts a denture wipe 20 used in conjunction with the present invention. Over the surface of the denture wipe 20 is a series of rippled ridges 25. The rippled ridges 25 help to clean denture cream off a set of dentures during the cleaning process. The wipe 20 may be made up of cotton or other fabric and the series of rippled ridges help to remove more cream from the dentures during the cleaning process. The wipe 20 may be moistened with an antibacterial mouthwash to provide a fresh breath sensation when the dentures are placed back in the user's mouth.

A denture cleaning tool 30 is shown in FIG. 2 that includes a set of bristles 32 at a first end and a knife 34 at a second end. A handle portion 36 is between the bristles 32 and knife 34 so that the user may manipulate the denture cleaning tool 30 as needed. The denture cleaning tool 30 helps the user to clean the dentures with the use of a brush and knife that allows the user to remove cream and residue from hard to reach areas of the dentures. The denture cleaning tool 30 may preferably be made of a plastic material and the bristles used in conjunction with denture wipe 20 allow the user to easily and effectively clean a set of dentures without the mess and residue usually associated with denture cleaning. Further the application of disinfectant to the wipe ensures that a fresh set of dentures is provided to the user after use thereof. The instant invention has been shown and described in what it considers to be the most practical and preferred embodiments. It is recognized, however, that departures may be made there from within the scope of the invention and that obvious modifications will occur to a person skilled in the art.

What is claimed is:

1. A denture cleaning kit comprising:
a. a wipe; and
b. a cleaning tool, wherein the cleaning tool is used with the wipe to clean dentures.

2. The denture cleaning kit according to claim 1, where the wipe includes a series of ridges over the surface.

3. The denture cleaning kit according to claim 1, where the cleaning tool includes a brush at a first end and a knife at a second end.

4. The denture cleaning kit according to claim 1, where the wipe is made of cotton.

5. The denture cleaning kit according to claim 1, where the cleaning tool is made of plastic.
